(19) United States
(12) Patent Application Publication
(10) Pub. No.: US 2001/0022436 A1
(43) Pub. Date: Sep. 20, 2001

(54) Shopping cart with wheeled support base preventing tip overs

(75) Inventor: Gilles Simard, Le Gardeur (CA)

Correspondence Address: MCDERMOTT, WILL & EMERY, 600, 13th Street, North-West, Washington, DC, 20005-3096, US

(73) Assignee: CARI-ALL INC.

(21) Appl. No.: 09/759,367

(22) Filed: Jan. 16, 2001

(30) Foreign Application Priority Data
Feb. 23, 2000 (CA) 2,299,817

(51) Int. Cl. B62B 3/14

(52) U.S. Cl. 280/33.991; 280/47.35

(57) ABSTRACT

A shopping cart including a basket and a basket support frame on which the basket is mounted. The basket support frame includes a base frame mounted on a pair of rear wheel assemblies and a pair of front wheel assemblies. The base frame has a front framing member defining the front end of the base frame and two side framing members, the front framing member forming a corner with each side framing member. The basket support frame further includes a mounting plate associated with each front wheel assembly to securely mount the same onto a respective corner of the base frame, each mounting plate having one side secured to the front framing member of the base frame and another side secured to the corresponding side framing member. These plates enable the front wheel assemblies to be securely, easily and inexpensively mounted to the base frame of the shopping cart. Furthermore, the wheeled base frame of the shopping cart is inherently more stable and designed so as to substantially decrease the risk of tip overs, thereby providing a safer shopping cart.

### FIELD OF THE INVENTION

The present invention relates to a shopping cart such as the ones used in supermarkets and the like. More particularly, it concerns a safe shopping cart having wheel assemblies which are easily, inexpensively, and securely mounted onto its base frame.

### BACKGROUND OF THE INVENTION

It is well known in the art that most grocery stores, supermarkets and other similar establishments provide shopping carts for their customers in order to facilitate collection and transportation of the products to be purchased.

The construction of a shopping cart is also commonly known in the art. A shopping cart usually comprises a support frame which is supported above ground by a base frame displaceable on wheel assemblies, such as casters for example. A container, commonly known as a “basket”, is usually secured to the support frame of the shopping cart and has a bottom wall, front, rear, and side walls. The upper end of the basket is open to permit the insertion of articles into the basket. A handle is usually supported rearwardly of the basket rear wall by a handle structure operatively connected to the wheeled base frame of the shopping cart by means of its support frame. The handle provides for the shopping cart to be pushed, pulled, and steered on the wheel assemblies. Shopping carts are generally utilized for transporting the goods to be purchased by a person walking through the above-mentioned establishments along with the cart.

It is also known in the art that most shopping carts are usually provided with a lower support rack located under the basket and secured across the wheeled base frame for further transporting goods to be purchased. The base frame is usually formed of a tubular member bent in a substantially U-shaped form defining opposed outwardly tapered side framing members and a shorter intermediate front framing member. A pair of rear casters and a pair of front casters are usually secured under the base frame adjacent the front and rear ends of the side framing members respectively so as to allow the user of the shopping cart to displace it over the ground surface of the commercial establishment. A flat mounting plate is usually secured transversely onto the base frame, adjacent the front framing member and spanning parallel thereto from one side framing member to the other, and under which is secured the front pair of casters.

Very often, the lower support rack is constructed of steel rods having portions resting on the top face of the mounting plate onto which the front casters are secured. A problem associated with the above-mentioned type of mounting plate is that, as it is known in the art, the heavy loads of the goods to be purchased which are dropped into the basket and, more particularly, onto the lower support rack, tend to bend and warp the mounting plate which is usually made of a long, narrow, and thin rectangular strip of metal. This in turn usually causes the front casters to become inappropriately misaligned. Therefore, it would be very useful to provide a shopping cart having wheel assemblies which are securely mounted onto its base frame.

Another problem associated with the above-mentioned type of mounting plate is that the mounting thereof onto the base frame is generally quite cumbersome due to, among other things, the intricate interconnection between the lower support rack and the mounting plate. Therefore, it would be very useful to provide a shopping cart having wheel assemblies which are easily mounted onto its base frame.

Yet another problem associated with the above-mentioned type of mounting plate is that the above-mentioned elaborate mounting of the mounting plate onto the base frame generally results in a greater number of assembling steps and processes, thereby resulting in higher manufacturing costs. Therefore, it would be very useful to provide a shopping cart having wheel assemblies which are inexpensively mounted onto its base frame.

It is also known in the art that with the advent of large warehouse-type shopping stores, it is common to see shopping carts filled to the top with several large and heavy purchase items which are often unevenly distributed in the basket, resulting in an unstable shopping cart. Also, these shopping carts typically have a seat within the basket which is designed to hold small children. Such child seats are very convenient for a shopper with a small child, however they are also inherently dangerous due to the high location of the seat. Furthermore, shoppers will usually be accompanied by their young children which are naturally very active and will often play in an unsafe manner with the shopping carts by pushing them, pulling down on the handle, riding on the wheeled base frame, or even climbing into the basket. Particularly, children will often climb onto the shopping cart by stepping on the front framing member of the wheeled base frame which extends past the front casters located directly under the basket and by holding onto the top edge of the basket. Their bodies are thus mounted onto the shopping cart in a slanted manner thereby generating a moment about the central axes of the front wheels which may cause the shopping cart to tip over due to the way conventional wheeled base frames of shopping carts are designed. Any of the above-mentioned factors or a combination thereof may cause the shopping cart to tip over resulting often in serious injuries to children or to the shoppers accompanying them. Indeed, it is known in the art that tip overs are one of the most common mechanisms of shopping cart-related injuries among young children. The shopping carts known in the art have narrow and short wheeled base frames, have relatively high centers of gravity, become relatively unstable when subjected to unevenly distributed loads, and as a result thereof tip over rather easily.

Therefore, it would be very useful to provide a shopping cart whose wheeled base frame is inherently more stable and designed so as to substantially decrease or even prevent the risk of tip overs.

### SUMMARY OF THE INVENTION

One object of the present invention is to provide a shopping cart which satisfies that need.

In accordance with the invention, that above object is achieved by a shopping cart comprising:

a basket having bottom, front, rear, and side walls;

a basket support frame on which is mounted the basket, the basket support frame comprising:

a base frame mounted on a pair of rear wheel assemblies and a pair of front wheel assemblies, the base frame comprising a front framing member defining the front end of the base frame and two side framing members, the front framing member forming a corner with each side framing member; and

a handle structure operatively connected to the base frame for displacing the shopping cart; and

a mounting plate associated with each front wheel assembly to securely mount the same onto a respective corner of the base frame, each mounting plate having one side secured to the front framing member of the base frame and another side secured to the corresponding side framing member.

Preferably, said one side and said another side of each mounting plate are respectively welded to the front framing member and the corresponding side framing member. This feature enables to securely, easily, and inexpensively mount each front wheel assembly onto the base frame of the shopping cart.

Preferably also, the front end of the base frame extends forwardly at or beyond the front wall of the basket such that the front wheel assemblies are positioned longitudinally at or beyond the front wall of the basket. This feature enables to provide a shopping cart whose wheeled base frame is inherently more stable and designed so as to substantially decrease the risk of tip overs, thereby providing a safer shopping cart.

The invention and its advantages will be better understood upon reading the following non-restrictive description of a preferred embodiment thereof, made with reference to the accompanying drawings.

### BRIEF DESCRIPTION OF THE DRAWINGS

FIG. 1 is a side view of a shopping cart according to a preferred embodiment of the invention.

FIG. 2 is a front view of the shopping cart shown in FIG. 1.

FIG. 3 is a cross-sectional view of the tubular member forming the base frame of the shopping cart shown in FIG. 1.

FIG. 4 is a top view of a front wheel assembly mounted onto a corner of the base frame of the shopping cart shown in FIG. 1.

FIG. 5 is a side view of the front wheel assembly shown in FIG. 4.

FIG. 6 is a front view of the front wheel assembly shown in FIG. 4.

### DETAILED DESCRIPTION OF A PREFERRED EMBODIMENT OF THE INVENTION

In the following description, the same numerical references refer to similar elements.

Moreover, it is worth mentioning that although the preferred embodiment of the invention as illustrated consists of a shopping cart having substantially triangular-shaped plates welded onto its base frame, it should be understood that, in the context of the present invention, expressions such as “triangular” and “welded” and any other equivalents and/or variants thereof, should not be taken in a restrictive sense to limit the scope of the invention since other embodiments for the plates of the shopping cart could be used with the invention, as will be described hereinafter and as apparent to a person skilled in the art. The same should be understood for expressions such as “children”.

In addition, in the context of the present description, the expressions “wheel assembly” and “caster” may be used interchangeably, as apparent to a person skilled in the art.

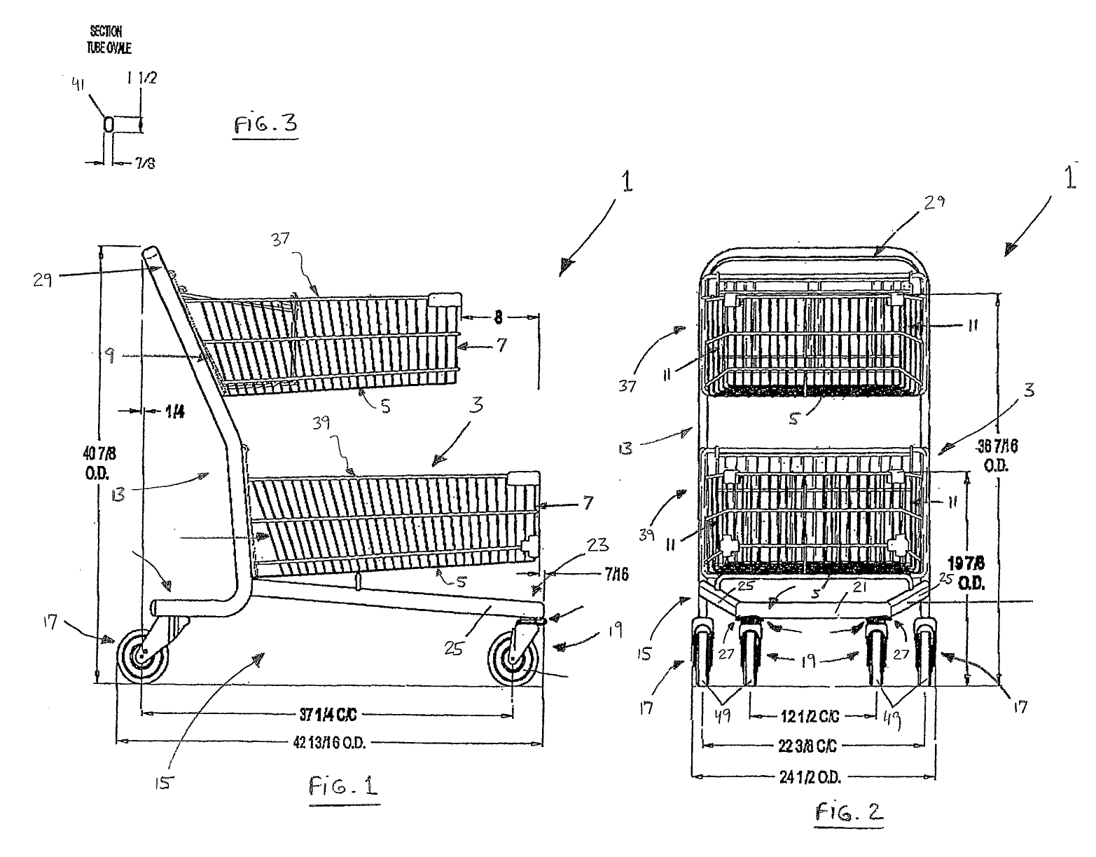

Broadly described, and referring to FIGS. 1 and 2, the shopping cart 1 according to a preferred embodiment of the invention as it is illustrated with accompanying drawings comprises a basket 3 and a basket support frame 13 on which is mounted the basket 3. The basket support frame 13 comprises a base frame 15 mounted on a pair of rear wheel assemblies 17 and a pair of front wheel assemblies 19. The base frame 15 comprises a front framing member 21 defining the front end 23 of the base frame 15 and two side framing members 25, the front framing member 21 forming a corner 27 with each side framing member 25. The basket, support frame 13 further comprises a mounting plate 31, which is preferably a substantially triangular-shaped support plate, associated with each front wheel assembly 19 to securely mount the same onto a respective corner 27 of the base frame 15. Each mounting plate 31 has one side 33 secured to the front framing member 21 of the base frame 15 and another side 35 secured to the corresponding side framing member 25.

The front end 23 of the base frame 15 preferably extends forwardly at or beyond the front wall 7 of the basket 3 such that the front wheel assemblies 19 are positioned longitudinally at or beyond the front wall 7 of the basket 3. Thanks to the front wheel assemblies 19 positioned in this manner, such shopping cart 1 is inherently more stable and designed so as to substantially decrease the risk of tip overs. It is thus safer than what is known in prior art.

Now, in more details and referring always to FIGS. 1 and 2, the shopping cart 1 comprises a top basket 3a and a bottom basket 3b and a handle structure 29 operatively connected to the base frame 15 for displacing the shopping cart 1 on the front and rear wheel assemblies 19, 17. Each basket 3 preferably has one bottom wall 5, one front wall 7, one rear wall 9, and two side walls 11. As can be easily understood, the number and the nature of the baskets 3 and wheel assemblies 17, 19 used may be varied depending on the particular applications for which the shopping cart 1 is intended, as apparent to a person skilled in the art.

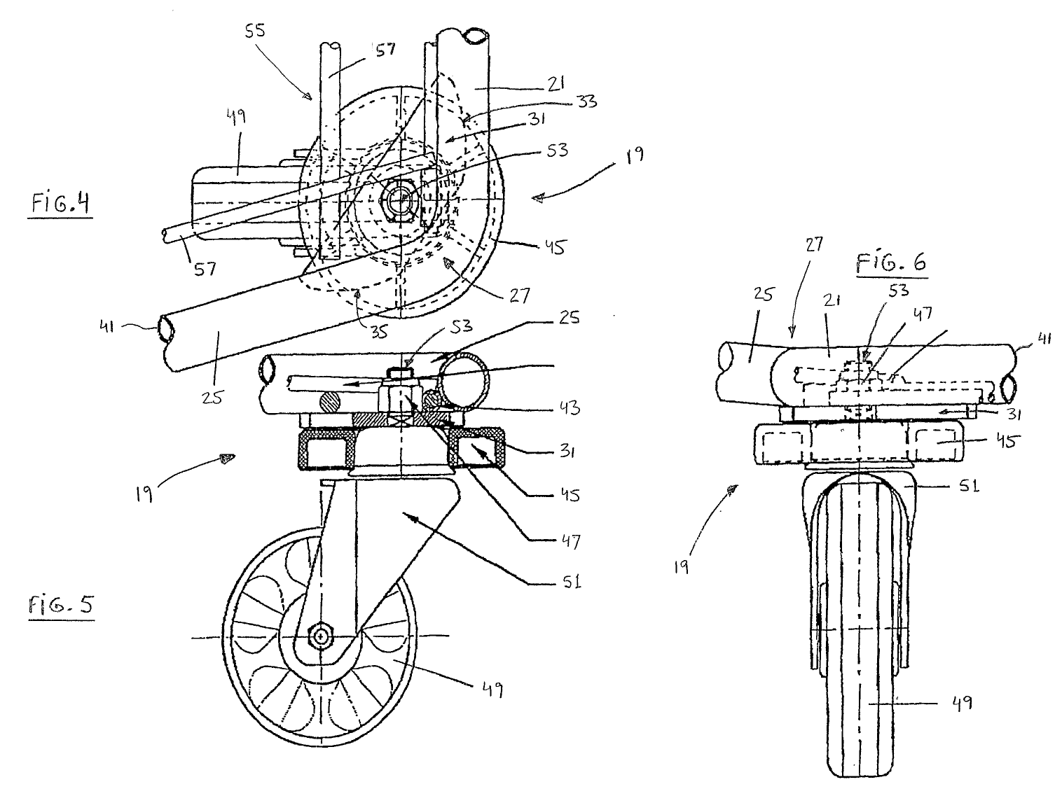

As better shown in FIG. 1, the two front wheel assemblies 19 are preferably positioned completely at the front end 23 of the base frame 15, preferably directly under the front wall 7 of the bottom basket 3b, and securely mounted onto the base frame 15 by means of the substantially triangular-shaped support plates 31 which will be explained in greater detail in reference to FIGS. 4 to 6. The front wheel assemblies 19 positioned in a such manner preferably help reduce the risk of the shopping cart 1 tipping over as a result of people, particularly children, stepping on the front framing member 21 of the base frame 15, as apparent to a person skilled in the art. It is worth noting that the front framing member 21 of the base frame 15 could extend beyond the front wall 7 of the bottom basket 3b. This would further reduce the risk of the shopping cart 1 tipping over as a result of people stepping on the front framing member 21 of the base frame 15, as also apparent to a person skilled in the art.

As also better shown in FIG. 1, the two rear wheel assemblies 17 are preferably positioned completely at the rear end 37 of the base frame 15, preferably directly under the handle structure 29. The rear wheel assemblies 17 positioned in a such manner help reduce the risk of the shopping cart 1 tipping over as a result of people, particularly children, pulling downward on the handle structure 29, among many other causes, as apparent to a person skilled in the art. It is worth noting that the rear wheel assemblies 17 could be mounted at the rear end of a base frame 15 extending beyond the handle structure 29. This would further reduce the risk of the shopping cart 1 tipping over, as also apparent to a person skilled in the art.

Preferably, the top basket 3a of the shopping cart 1 has a grain capacity of 5 442 cu/in and a payload capacity of 7 498 cu/in. Preferably also, the bottom basket 3b of the shopping cart 1 has a grain capacity of 5 725 cu/in and a payload capacity of 7 915 cu/in. The resulting payload capacity of the shopping cart 1 is thus preferably 15 413 cu/in and the shopping cart 1 has preferably a cart weight of 55 lbs and a cart nesting of 10 ⅞ in. The dimensions shown in FIGS. 1 and 2 are in inches and are preferential. It is worth noting that the above-mentioned dimensions and characteristics as well as the number and the nature of the components used in the shopping cart 1 may be changed to accommodate particular needs, as apparent to a person skilled in the art.

Referring now to FIG. 3, the base frame 15 is preferably formed of a hollow tubular member 41 having an oval-shaped cross-section. Preferably also, the tubular member 41 is 1 ½ in along the length of its cross-section and ⅞ in along the width, as also better shown in FIG. 3. Similarly, it can be easily understood that other shapes and sizes for the tubular member 41 may be used depending on the particular applications of the shopping cart 1, as apparent to a person skilled in the art.

Referring now to FIGS. 4 to 6 and as aforementioned, the front wheel assemblies 19 are securely mounted at the front end corners 27 of the base frame 15 by means of the mounting plates 31. More particularly, one mounting plate 31 is preferably associated with each front wheel assembly 19 to securely mount the same onto a respective corner 27 of the base frame 15, each mounting plate 31 having one side 33 secured to the front framing member 21 of the base frame 15 and another side 35 secured to the corresponding side framing member 25, as better shown in FIG. 4. As mentioned before, the mounting plate 31 preferably has a generally triangular shape. However, it should be understood, that it may take other forms such as a rectangular shape, a square shape, rounded shape, elliptical shape, etc., as long as it is mounted at the front end corner 27 with one side 33 secured to the front framing member 21 and the other side 35 secured to the side framing member 25. As better shown in FIGS. 5 and 6, each front wheel assembly 19 preferably comprises a bushing 43, a bumper 45, a nut 47, a caster wheel 49, a caster swivel 51, and a king pin 53. Preferably, the king pin 53 of each front wheel assembly 19 is securely mounted onto the corresponding triangular-shaped support plate 31 associated thereto. It is worth noting that the front wheel assemblies 19 may consist of other suitable components, as apparent to a person skilled in the art.

As better shown in FIGS. 2, 4 and 6, the base frame 15 comprises a front framing member 21 defining the front end 23 of the base frame 15 and two side framing members 25. The front and side framing members 23, 25 are preferably made integral to one another, that is, are preferably made of one single piece, i.e. a single tubular member 41 bent in a substantially U-shaped form. The front framing member 21 preferably forms a substantially L-shaped corner 27 with each side framing member 25, as better shown in FIG. 4. One front wheel assembly 19 is mounted at each corner 27 of the base frame 15 by means of one substantially triangular-shaped support plate 31.

As also better shown in FIG. 4, each substantially triangular-shaped support plate 31 has one side 33 welded onto the front framing member 21 and another side 35 welded onto the corresponding side framing member 25. Preferably also, each triangular-shaped plate 31 is made of metal. It is worth mentioning that other suitable materials, such as reinforced composites for example, and other suitable shapes, such as rectangular form for example, may be used for the support plates 31, as apparent to a person skilled in the art. It is also worth mentioning that the sides 33, 35 of each substantially triangular-shaped support plate 31 may be rigidly affixed to the corresponding front and side framing members 21, 25 by other suitable means, such as by being formed integrally thereto through molding for example, as also apparent to a person skilled in the art. Moreover, the thickness of the support plates 31 is chosen accordingly, as also apparent to a person skilled in the art. The substantially triangular-shaped support plates 31 are preferably small and inexpensive, thus making mounting of the front wheel assemblies 19 onto the base frame 15 in the above-described manner very functional and cost effective. The base frame 15 of the shopping cart 1 may also comprise a lower support rack 55 formed of thin rods 57 for example, as it is well known in the art.

As may now be appreciated, the present invention is a substantial improvement over the shopping carts known in the art. Firstly, the shopping cart 1 according to the present invention is advantageous in that it has wheel assemblies 19 which can easily, inexpensively, and securely be mounted onto its base frame by means of mounting plates 31, as explained hereinabove. Moreover, another substantial improvement of the present invention over the shopping carts known in the art is that the wheeled base frame 15, as also explained hereinabove, is inherently more stable and designed so as to substantially decrease the risk of tip overs, thereby providing a shopping cart which is safer than the ones known in the art.

Of course, numerous modifications could be made to the above-described embodiments without departing the scope of the invention as defined in the appended claims.

1. A shopping cart comprising:
a basket having bottom, front, rear, and side walls;
a basket support frame on which is mounted said basket, said basket support frame comprising:
a base frame mounted on a pair of rear wheel assemblies and a pair of front wheel assemblies, said base frame comprising a front framing member defining the front end of the base frame and two side framing members, said front framing member forming a corner with each side framing member; and
a handle structure operatively connected to the base frame for displacing the shopping cart; and
a mounting plate associated with each front wheel assembly to securely mount the same onto a respective corner of the base frame, each mounting plate having one side secured to the front framing member of the base frame and another side secured to the corresponding side framing member.

2. A shopping cart according to claim 1, wherein said one side and said another side of each mounting plate are respectively welded to the front framing member and the corresponding side framing member.

3. A shopping cart according to claim 1, wherein each front wheel assembly comprises a caster having a king pin securely mounted onto the corresponding mounting plate associated thereto.

4. A shopping cart according to claim 1, wherein the front end of the base frame extends forwardly at or beyond the front wall of the basket such that the front wheel assemblies are positioned longitudinally at or beyond the front wall of the basket.

5. A shopping cart according to claim 1, wherein each mounting plate is a triangular-shaped support plate.

6. A shopping cart according to claim 1, wherein mounting plate is made of metal.

7. A shopping cart according to claim 1, wherein each front wheel assembly is provided with a bumper.

8. A shopping cart comprising:
a basket having bottom, front, rear, and side walls;
a basket support frame on which is mounted said basket, said basket support frame comprising:
a base frame mounted on a pair of rear wheel assemblies and a pair of front wheel assemblies, said base frame comprising a front framing member defining the front end of the base frame and two side framing members, said front framing member forming a corner with each side framing member; and
a handle structure operatively connected to the base frame for displacing the shopping cart; and
a substantially triangular-shaped support plate associated with each front wheel assembly to securely mount the same onto a respective corner of the base frame, each substantially triangular-shaped support plate having one side secured to the front framing member of the base frame and another side secured to the corresponding side framing member; wherein said one side and said another side of each triangular-shaped support plate are respectively welded to the front framing member and the corresponding side framing member; and wherein each front wheel assembly comprises a caster having a king pin securely mounted onto the corresponding triangular-shaped support plate associated thereto.

9. A shopping cart according to claim 8, wherein the front end of the base frame extends forwardly at or beyond the front wall of the basket such that the front wheel assemblies are positioned longitudinally at or beyond the front wall of the basket.
